(19) United States
(12) Patent Application Publication
(10) Pub. No.: US 2014/0215152 A1
(43) Pub. Date: Jul. 31, 2014

(54) EXPANDABLE MULTIMEDIA STORAGE SYSTEM, MULTIMEDIA DISTRIBUTION DEVICE, AND RELEVANT COMPUTER PROGRAM PRODUCT

(71) Applicant: ELTA Technology Co., Ltd., Taipei City (TW)

(72) Inventors: Tze-Yi CHENG, Taipei City (TW); Li-Wen CHEN, Taipei City (TW); Yuan-Yu CHEN, Taipei City (TW); Yu-Sheng HO, Taipei City (TW)

(73) Assignee: ELTA Technology Co., Ltd., Taipei City (TW)

(21) Appl. No.: 14/143,777

(22) Filed: Dec. 30, 2013

(30) Foreign Application Priority Data
Jan. 25, 2013 (TW) 102103031

(51) Int. Cl. G06F 3/06

(52) U.S. Cl. CPC G06F 3/0689; G06F 3/0619; G06F 3/0647
USPC 711/114

(57) ABSTRACT

A multimedia storage system includes a multimedia distribution device and a plurality of storage devices. The multimedia distribution device splits a multimedia file into a plurality of multimedia segments and monitors the operation statuses of the storage devices. The multimedia distribution device further configures each of the multimedia segments to be stored in at least two of the storage devices according to the available storage devices in the multimedia storage system. The storage device comprises a network access device for receiving the multimedia segments and a redundant array of inexpensive disks for storing the received multimedia segments.

### CROSS-REFERENCE TO RELATED APPLICATIONS

This application claims the benefit of priority to Patent Application No. 102103031, filed in Taiwan on Jan. 25, 2013; the entirety of which is incorporated herein by reference for all purposes.

### BACKGROUND

The disclosure generally relates to a multimedia storage system and, more particularly, to an expandable multimedia storage system.

Along with the progress of the communication technologies, multimedia content are available to be played on TV, computers, mobile phones, tablet computers and other mobile devices. Moreover, the file size of the multimedia content has been increasing for providing better audio and video effects. For example, it takes several or dozen gigabytes of storage space for the high-definition and 3-D multimedia content stored on DVD and Blu-ray Disc. Thus, the multimedia content providers usually need several terabytes or petabytes of storage space for storing the multimedia content.

Because the number of multimedia files and the file size keep increasing, it often takes a long time and a lot of network bandwidth to store and access the multimedia files. The performance of traditional data storage system and the bandwidth of the network have limited the performance when providing the multimedia content. Moreover, the traditional data storage system may not be easily expanded. When the storage capacity of the data storage system is insufficient, it takes a long time to transfer data from the old storage devices to the new storage devices. It becomes a critical challenge for the multimedia content provider to efficiently store the enormous number and huge file-sized multimedia content.

### SUMMARY

In view of the foregoing, it may be appreciated that a substantial need exists for methods and apparatuses that mitigate or reduce the problems above.

An example embodiment of a multimedia storage system is disclosed, comprising: a plurality of first storage devices, each of which comprises at least one network access device and at least one disk drive device; and a multimedia distribution device for splitting a first multimedia file into a plurality of multimedia segments and splitting a second multimedia file into a plurality of multimedia segments; wherein in a first period, the multimedia distribution device is coupled with the first storage devices for storing the multimedia segments of the first multimedia file into the first storage devices so that each of the multimedia segments of the first multimedia file is stored in at least two of the first storage devices; and in a second period, the multimedia distribution device is coupled with the first storage devices and a plurality of second storage devices for storing the multimedia segments of the second multimedia file so that each of the multimedia segments of the second multimedia file is stored in at least two of the first storage devices and the second storage devices; wherein each of the second storage device comprises at least one network access device and at least one disk drive device; the network access devices of the first storage devices and the network access devices of the second storage devices are configured to operably receive the multimedia segments of the first multimedia file and the multimedia segments of the second multimedia file; the disk drive devices of the first storage devices and the disk drive devices of the second storage devices are configured to operably store the multimedia segments of the first multimedia file and the multimedia segments of the second multimedia file; the multimedia distribution device splits the first multimedia file so that each of the multimedia segments of the first multimedia file comprises a multimedia content of a continuous time period and starts with an intra frame; and at least two of the multimedia segments of the first multimedia file have different sizes.

Another example embodiment of a multimedia distribution device of a multimedia storage system, comprising: a multimedia splitting module for splitting a first multimedia file into a plurality of multimedia segments and splitting a second multimedia file into a plurality of multimedia segments; wherein each of the multimedia segments of the first multimedia file comprises a multimedia content of a continuous time period and starts with an intra frame; each of the multimedia segments of the second multimedia file comprises a multimedia content of a continuous time period and starts with an intra frame; at least two of the multimedia segments of the first multimedia file have different sizes; and at least two of the multimedia segments of the second multimedia file have different sizes; a storage monitoring module for monitoring operation statuses of a plurality of storage devices; a multimedia segment transmission module for coupling with a plurality of first storage devices for storing the multimedia segments of the first multimedia file into the first storage devices in a first period so that each of the multimedia segments of the first multimedia file is stored in at least two of the first storage devices, and coupling with the first storage devices and a plurality of second storage devices for storing the multimedia segments of the second multimedia file in a second period so that each of the multimedia segments of the second multimedia file is stored in at least two of the first storage devices and the second storage devices; wherein each of the first storage devices and the second storage devices comprises at least one network access device and at least one disk drive device; the network access devices of the first storage devices and the network access devices of the second storage devices are configured to operably receive the multimedia segments of the first multimedia file and the multimedia segments of the second multimedia file; and the disk drive devices of the first storage devices and the disk drive devices of the second storage devices are configured to operably store the multimedia segments of the first multimedia file and the multimedia segments of the second multimedia file.

Another example embodiment of a computer program product, stored in a non-transitory storage device of a multimedia distribution device, when executed by a control circuit of the multimedia distribution device, enabling the multimedia distribution device to perform a multimedia storing operation, the computer program product comprising: splitting a first multimedia file into a plurality of multimedia segments; wherein each of the multimedia segments of the first multimedia file comprises a multimedia content of a continuous time period and starts with an intra frame, and at least two of the multimedia segments of the first multimedia file have different sizes; splitting a second multimedia file into a plurality of multimedia segments; wherein each of the multimedia segments of the second multimedia file comprises a multimedia content of a continuous time period and starts with an intra frame, and at least two of the multimedia segments of the second multimedia file have different sizes; monitoring operation statuses of a plurality of storage devices; in a first period, storing the multimedia segments of the first multimedia file into a plurality of first storage devices so that each of the multimedia segments of the first multimedia file is stored in at least two of the first storage devices; and in a second period, storing the multimedia segments of the second multimedia file into the first storage devices and a plurality of second storage devices so that each of the multimedia segments of the second multimedia file is stored in at least two of the first storage devices and the second storage devices; wherein each of the first storage devices and the second storage devices comprises at least one network access device and at least one disk drive device; the network access devices of the first storage devices and the network access devices of the second storage devices are configured to operably receive the multimedia segments of the first multimedia file and the multimedia segments of the second multimedia file; and the disk drive devices of the first storage devices and the disk drive devices of the second storage devices are configured to operably store the multimedia segments of the first multimedia file and the multimedia segments of the second multimedia file.

Both the foregoing general description and the following detailed description are examples and explanatory only, and are not restrictive of the invention as claimed.

### BRIEF DESCRIPTION OF THE DRAWINGS

FIG. 1 shows a simplified functional block diagram of a multimedia storage system according to one embodiment of the present disclosure.

FIG. 2 shows a simplified operation flowchart of the multimedia storage system in FIG. 1 according to one embodiment of the present disclosure.

FIGS. 3-6 show several simplified schematic diagram of the multimedia storage system in FIG. 1 according to several embodiments of the present disclosure.

### DETAILED DESCRIPTION

Reference is made in detail to embodiments of the invention, which are illustrated in the accompanying drawings. The same reference numbers may be used throughout the drawings to refer to the same or like parts, components, or operations.

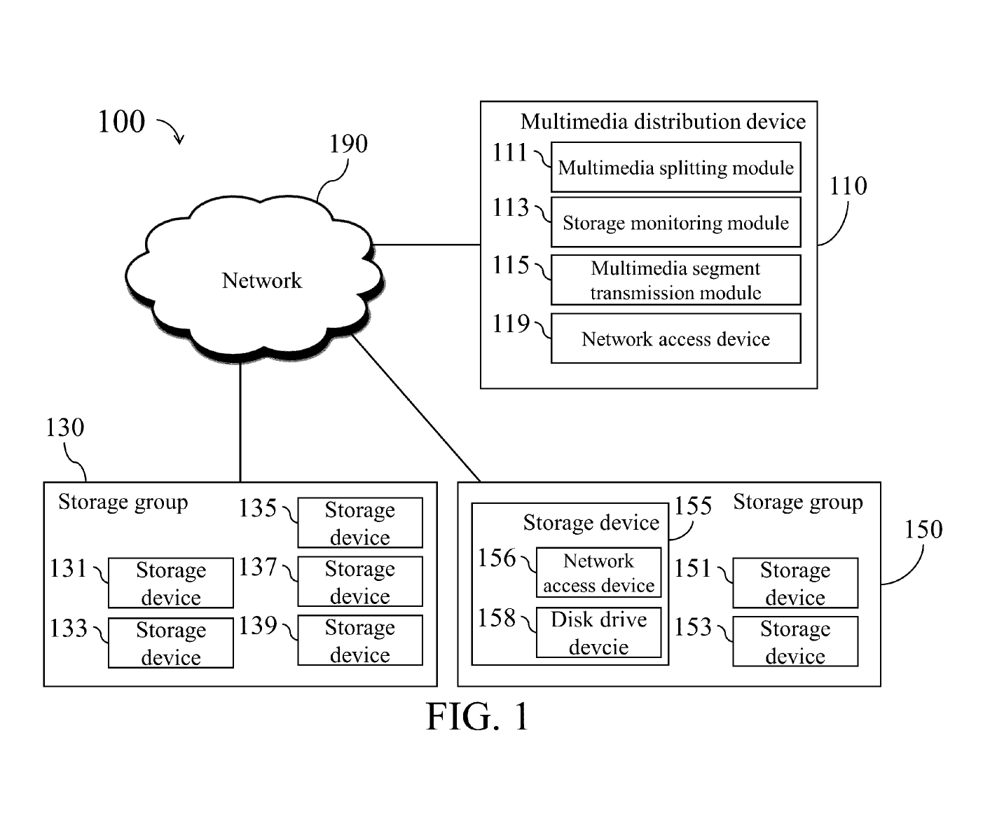

FIG. 1 shows a simplified functional block diagram of a multimedia storage system 100 according to one embodiment of the present disclosure. The multimedia storage system 100 comprises a multimedia distribution device 110, a first storage group 130, a second storage group 150 and a network 190. The multimedia storage system 100 may be configured to operably store multimedia files and provide multimedia files to other devices.

In this embodiment, the multimedia distribution device 110 comprises a multimedia splitting module 111, a storage monitoring module 113, a multimedia segment transmission module 115 and a network access module 119.

The multimedia splitting module 111 is configured to operably split the multimedia file into a plurality of multimedia segments for storing in the storage devices of the multimedia storage system 100.

The storage monitoring module 113 is configured to operably monitor the operation statuses of the storage devices so that the multimedia distribution device 110 may perform suitable access operations to the storage devices.

The multimedia segment transmission module 115 is configured to operably transmit and store the multimedia segments to the storage devices of the multimedia storage system 100.

The multimedia splitting module 111, the storage monitoring module 113 and the multimedia segment transmission module 115 may be realized with software, hardware, firmware and the suitable combination thereof. For example, in one embodiment, the multimedia distribution device 110 comprises a control circuit (not shown in FIG. 1; e.g., microprocessor, digital signal processor, and ASIC) and a computer program stored in a non-transitory storage device (not shown in FIG. 1) for performing the function of the multimedia splitting module 111, the storage monitoring module 113 and/or the multimedia segment transmission module 115. In other embodiments, the multimedia distribution device 110 may be realized with integrated circuit elements and/or discrete circuit elements for performing the function of the multimedia splitting module 111, the storage monitoring module 113 and the multimedia segment transmission module 115.

The network access device 119 is configured to operably couple with the network 190 for performing the transmission and the reception of the multimedia files and the multimedia segments.

In this embodiment, the multimedia distribution device 110 performs multimedia storing operations with the storage group 130 first, and, after a period of time, the storage group 150 is coupled to the multimedia distribution device 110 for performing multimedia storing operations. In the embodiment in FIG. 1, the storage group 130 comprises storage devices 131, 133, 135, 137 and 139, and the storage group 150 comprises storage devices 151, 153 and 155. In other embodiments, the storage groups 130 and 150 may respectively comprise suitable number of storage device(s). For example, in another embodiment, the storage groups 130 and 150 may respectively comprise only one storage device.

Each of the storage devices of the storage groups 130 and 150 respectively comprises a network access device and a disk drive device. For example, the storage device 155 comprises a network access device 156 and a disk drive device 158. Other components and connections of the storage device 131, 133, 135, 137, 139, 151, 153 and 155 are not shown in FIG. 1 for the purposes of conciseness and clear explanation.

The storage device may receive multimedia segments transmitted by the multimedia distribution device 110 through the network device, and store the multimedia segments in the disk drive device. The storage device may also provide the multimedia segments stored in the disk drive device through the network access device to other multimedia players. The disk drive device may be realized with any suitable equipment, e.g., redundant array of inexpensive disk (RAID) for storing the multimedia segments transmitted by the multimedia distribution device 110. Moreover, when the disk drive device is realized with RAID, the RAID may be configured to adopt RAID 0, RAID 1, RAID 5, JBOD or other suitable configurations.

The network 190 may comprise any suitable wired and wireless network, e.g., IEEE 802.3 Ethernet network and IEEE 802.11 WLAN network.

For the purposes of conciseness and clear explanation, some components and connections of the multimedia storage system 100 are not shown in FIG. 1. For example, the storage groups 130 and 150 may respectively comprise more storage devices and the storage devices may respectively comprise other components.

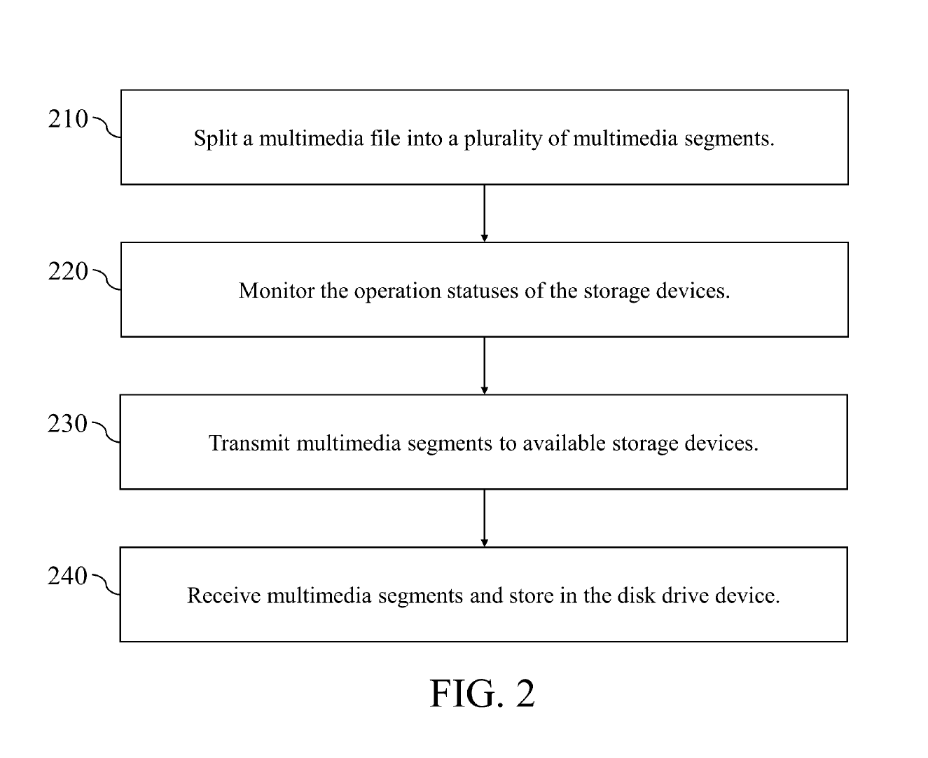

FIG. 2 shows a simplified operation flowchart of the multimedia storage system in FIG. 1 according to one embodiment of the present disclosure. The operation of the multimedia storage system 100 is further explained below with FIGS. 1 and 2.

In the operation 210, the multimedia splitting module 111 splits a multimedia file into a plurality of multimedia segments.

In the operation 220, the storage monitoring module 113 monitors the operation statuses of the storage devices to determine how many storage devices are coupled with the multimedia distribution device 110 and how many storage devices are suitable for storing the multimedia segments. The storage monitoring module 113 may communicate with the storage devices with standard communication protocols or custom defined protocols for detecting the connection status, the available storage space, the power consumption mode, the access frequency and the access number of the storage device. Therefore, the storage monitoring module 113 may be aware of which storage devices are suitable for storing the multimedia segments. For example, the storage monitoring device 113 may detect the connection status between a storage device and the multimedia distribution device 110 by using the “PING” command and detect the available storage space of the storage device by using the “df” command.

In the operation 230, according to the monitoring record of the storage monitoring module 113, the multimedia segment transmission module 115 transmits the multimedia segments to available storage devices through the network access device 190. Moreover, according to the redundancy configuration of the multimedia storage device 100, the multimedia segment transmission module 115 configures each of multimedia segments to be stored in two or more storage devices to enhance the reliability of the multimedia segments. For example, when the redundancy configuration of the multimedia storage device is configured to be N, the multimedia segment transmission module 115 configures each of multimedia segments to be duplicated to N+1 copies which are respectively transmitted and stored in N+1 different storage devices.

In the operation 240, the storage devices receives the multimedia segments through the network access device of the storage device, and stores the received multimedia segments in the disk drive device.

In the operation 210, the multimedia splitting module 110 may perform the splitting operation according to the characteristic of the multimedia file to enhance the efficiency of the multimedia storing operations. The video and audio data of the multimedia files are usually encoded (e.g., according to the MPEG2 and MPEG4 standards) according to the characteristic of the multimedia file. In one embodiment, the multimedia file comprises intra pictures (a.k.a. intra frames or I frames), predicted pictures (a.k.a. predicted frames or P frames) and bidirectional pictures (a.k.a. bidirectional frames or B frames), and the multimedia splitting module 111 may split the multimedia file accordingly. Thus, each of the multimedia segments split by the multimedia splitting module 111 comprises a multimedia content of a continuous time period and starts with an intra frame. Compared with traditional data storage systems which split the file equally into the same size, at least two of the multimedia segments split by the multimedia splitting module 111 have different sizes.

When the multimedia splitting module 111 splits the multimedia file into the multimedia segments according to the characteristic of the multimedia file. Each of the multimedia segments comprises a multimedia content of a continuous time period and may be playable independent of other multimedia segments. Therefore, when the user wants to watch the multimedia content in a specific time period, there is a greater chance that a single multimedia segment comprises the required multimedia content. The multimedia storage system 100 may have a low chance to configure two storage devices to simultaneously provide the multimedia segments for the required multimedia content. The computation loading and the network bandwidth may therefore be reduced and the performance of the multimedia storage system 100 may be enhanced.

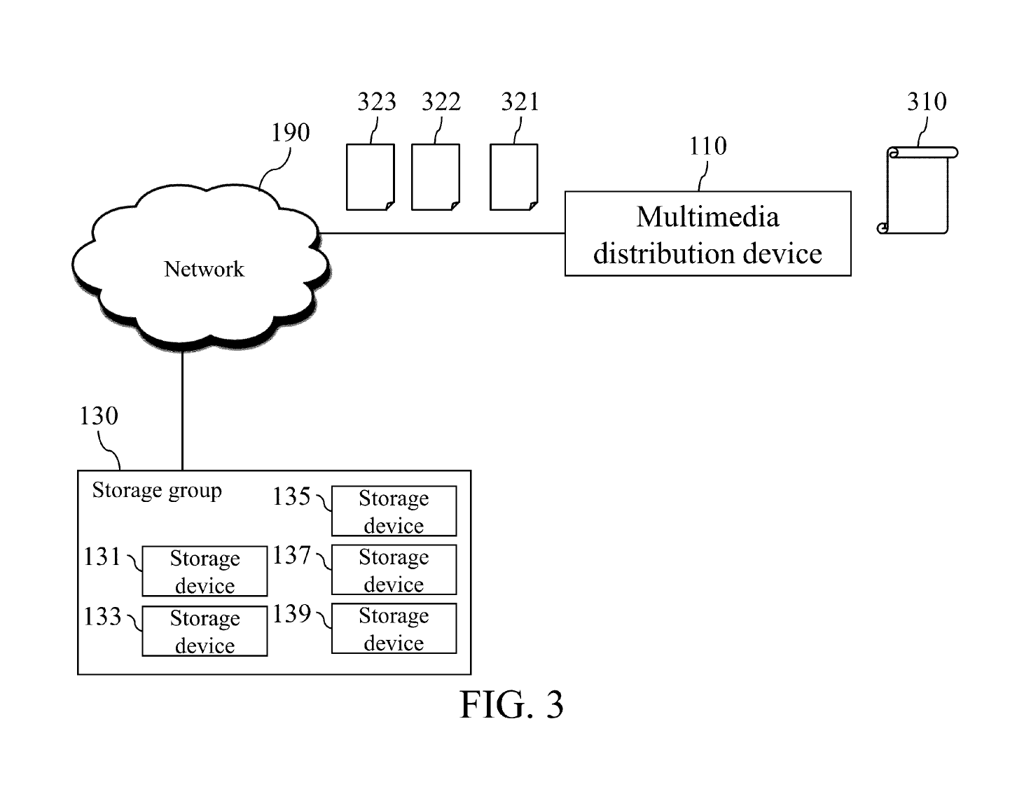

FIGS. 3-6 show several simplified schematic diagram of the multimedia storage system in FIG. 1 according to several embodiments of the present disclosure. The operation of the multimedia storage system 100 is further explained below with FIGS. 1-6.

In the embodiment in FIG. 3, the multimedia distribution device 110 stores the multimedia segments to the storage group 130.

The multimedia splitting module 111 splits a multimedia file 310 into three multimedia segments 321, 322 and 323.

The storage monitoring module 113 monitors the operation statuses of the storage devices 131, 133, 135, 137 and 139 through the network access device 190, and detects the above storage devices are available to store multimedia segments.

According to the monitoring record of the storage monitoring device 113, the multimedia segment transmission module 115 transmits the multimedia segments 321, 322 and 323 to the storage devices 131, 133, 135, 137 and 139, and configures each of the multimedia segments 321, 322 and 323 to be stored in at least two of the storage devices 131, 133, 135, 137 and 139. In this embodiment, the redundancy configuration N is configured to be 1. Thus, the multimedia segment transmission module 115 configures each of the multimedia segments 321, 322 and 323 is stored in two different storage device of the storage devices 131, 133, 135, 137 and 139. For example, the multimedia segment 321 is configured to be stored in storage device 131 and 133. The multimedia segment 322 is configured to be stored in storage device 131 and 135. The multimedia segment 323 is configured to be stored in storage device 137 and 139.

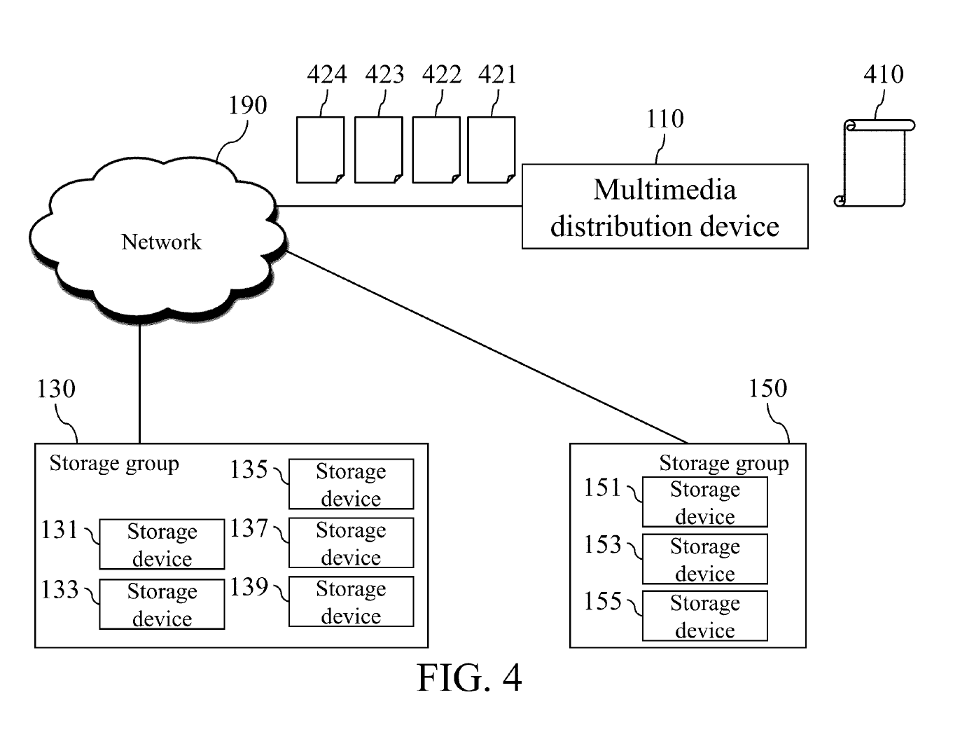

In the embodiment in FIG. 4, the multimedia distribution device 110 stores the multimedia segments to the storage groups 130 and 150.

The multimedia splitting module 111 splits a multimedia file 410 into three multimedia segments 421, 422, 423 and 424.

The storage monitoring module 113 monitors the operation statuses of the storage devices 131, 133, 135, 137, 139, 151, 153 and 155 through the network access device 190, and detects the above storage devices are available to store multimedia segments.

According to the monitoring record of the storage monitoring device 113, the multimedia segment transmission module 115 transmits the multimedia segments 421, 422, 423 and 424 to the storage devices 131, 133, 135, 137, and 139 of the storage group 130 and the storage devices 151, 153 and 155 of the storage group 150, and configures each of the multimedia segments 421, 422, 423 and 424 to be stored in at least two of the storage devices 131, 133, 135, 137, 139, 151, 153 and 155. In this embodiment, the redundancy configuration N is configured to be 1. Thus, the multimedia segment transmission module 115 configures each of the multimedia segments 421, 422, 423 and 424 is stored in two different storage device of the storage devices 131, 133, 135, 137, 139, 151, 153 and 155. For example, the multimedia segment 421 is configured to be stored in storage device 131 and 133. The multimedia segment 422 is configured to be stored in storage device 133 and 155. The multimedia segment 423 is configured to be stored in storage device 151 and 153. The multimedia segment 424 is configured to be stored in storage device 139 and 151.

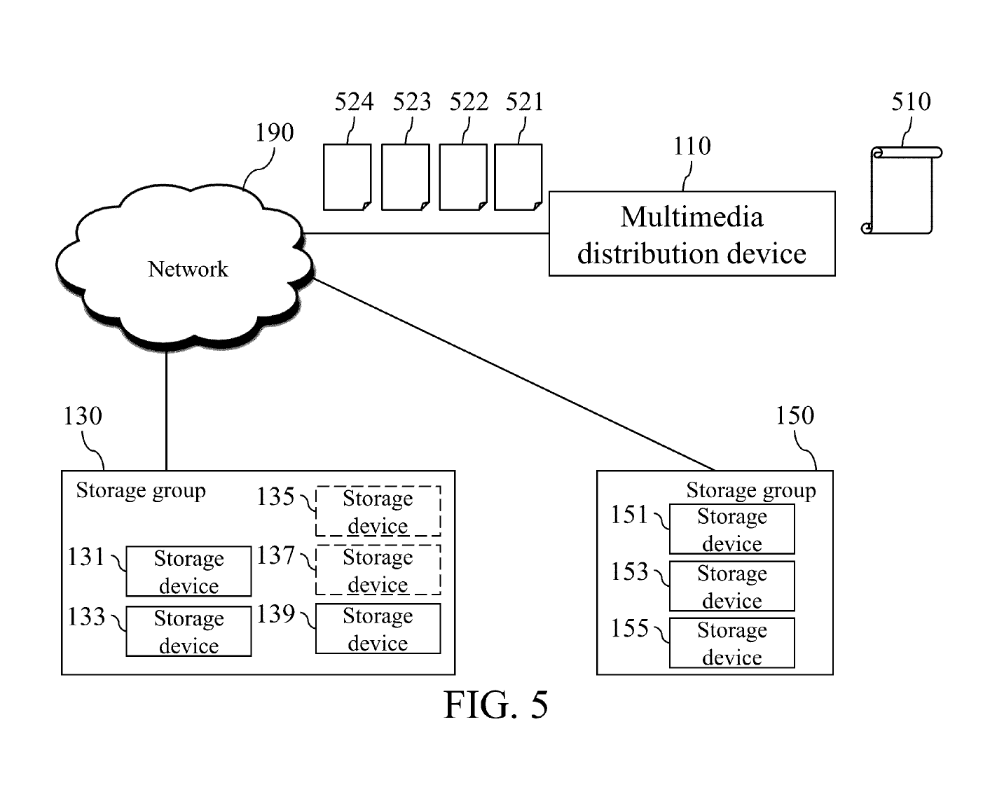

In the embodiment in FIG. 5, the multimedia distribution device 110 stores the multimedia segments to the storage groups 130 and 150. Moreover, the storage devices 135 and 137 enter the low power consumption power and are temporarily not available for storing multimedia segments.

The multimedia splitting module 111 splits a multimedia file 510 into three multimedia segments 521, 522, 523 and 524.

The storage monitoring module 113 monitors the operation statuses of the storage devices 131, 133, 135, 137, 139, 151, 153 and 155 through the network access device 190, and detects the storage devices 131, 133, 139, 151, 153 and 155 are available to store multimedia segments.

According to the monitoring record of the storage monitoring device 113, the multimedia segment transmission module 115 transmits the multimedia segments 521, 522, 523 and 524 to the storage devices 131, 133, 139 of the storage group 130 and the storage devices 151, 153 and 155 of the storage group 150, and configures each of the multimedia segments 521, 522, 523 and 524 to be stored in at least two of the storage devices 131, 133, 139, 151, 153 and 155. In this embodiment, the redundancy configuration N is configured to be 1. Thus, the multimedia segment transmission module 115 configures each of the multimedia segments 521, 522, 523 and 524 is stored in two different storage device of the storage devices 131, 133, 139, 151, 153 and 155. For example, the multimedia segment 521 is configured to be stored in storage device 133 and 139. The multimedia segment 522 is configured to be stored in storage device 131 and 151. The multimedia segment 523 is configured to be stored in storage device 151 and 153. The multimedia segment 524 is configured to be stored in storage device 139 and 155.

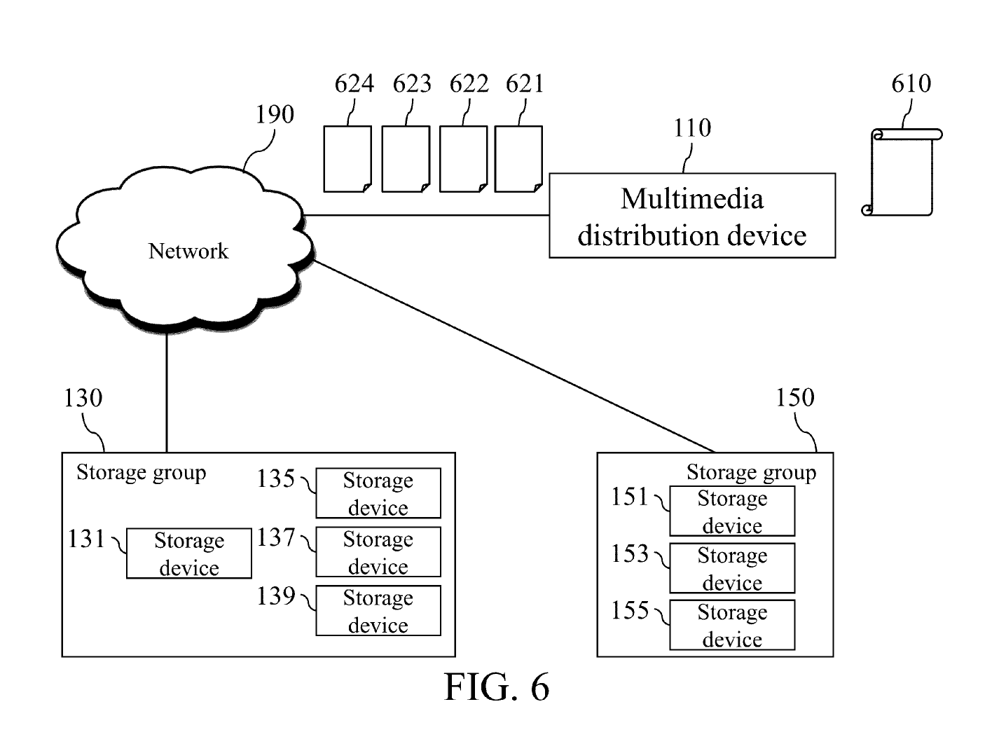

In the embodiment in FIG. 6, the multimedia distribution device 110 stores the multimedia segments to the storage groups 130 and 150. Moreover, the storage device 133 does not operate normally and is no longer available for storing multimedia segments.

The multimedia splitting module 111 splits a multimedia file 610 into three multimedia segments 621, 622, 623 and 624.

The storage monitoring module 113 monitors the operation statuses of the storage devices 131, 133, 135, 137, 139, 151, 153 and 155 through the network access device 190, and detects the storage devices 131, 135, 137, 139, 151, 153 and 155 are available to store multimedia segments.

According to the monitoring record of the storage monitoring device 113, the multimedia segment transmission module 115 transmits the multimedia segments 621, 622, 623 and 624 to the storage devices 131, 135, 137, and 139 of the storage group 130 and the storage devices 151, 153 and 155 of the storage group 150, and configures each of the multimedia segments 621, 622, 623 and 624 to be stored in at least two of the storage devices 131, 135, 137, 139, 151, 153 and 155. In this embodiment, the redundancy configuration N is configured to be 1. Thus, the multimedia segment transmission module 115 configures each of the multimedia segments 621, 622, 623 and 624 is stored in two different storage device of the storage devices 131, 135, 137, 139, 151, 153 and 155. For example, the multimedia segment 621 is configured to be stored in storage device 131 and 135. The multimedia segment 622 is configured to be stored in storage device 137 and 153. The multimedia segment 623 is configured to be stored in storage device 151 and 155. The multimedia segment 624 is configured to be stored in storage device 135 and 155.

Moreover, in the embodiment in FIG. 6, because the storage device 133 do not operate normally and is no longer available for storing multimedia segments, the multimedia segment transmission module 115 reproduces the multimedia segments originally stored in the storage device 133 according to the multimedia segments stored in the storage devices 131, 133, 135, 137 and 139 of the storage group 130 and storage devices 151, 153 and 155 of the storage group 150. For example, in the embodiment in FIG. 6, the multimedia segments 321 and 421 stored in the storage device 133 may be reproduced according the same multimedia segments stored in the storage device 131. The multimedia segments 422 stored in the storage device 133 may be reproduced according the same multimedia segments stored in the storage device 155. The multimedia segments 521 stored in the storage device 133 may be reproduced according the same multimedia segments stored in the storage device 139. The multimedia segment transmission module 115 may perform the corresponding reproduction operations so that each of the multimedia segments is still stored in two different storage devices of the storage devices 131, 134, 137, 139, 151, 153, and 155. The redundancy configuration of the multimedia storage system 100 is therefore still maintained to be 1. When the redundancy configuration of the multimedia storage system 110 is configured to be N, the multimedia segments may still be reproduced according to the normally functioned storage devices even if there are N storage device may not function normally.

In the above embodiments, when the multimedia distribution module 115 performing the distribution operation of the multimedia segments according to the monitoring record of the storage monitoring module 113, the multimedia transmission module 115 may select the storage devices which are more suitable for storing the multimedia segments according to different criteria. The multimedia segment transmission module 115 may select suitable storage devices according to at least one of an available storage space, an access frequency and an access number of the storage devices. For example, the multimedia segment transmission module 115 may select the storage devices with a larger available storage space, with a smaller available storage space, with a lower access frequency, with a higher access frequency, with fewer access numbers, or with more access numbers so that the multimedia storage system 110 may be operate more efficiently.

In the above embodiments, the order of the operations of the multimedia storage system 100 may be suitably adjusted. For example, in the embodiment in FIG. 2, the operation 220 may also be performed before the operation 210. The storage monitoring module 113 may monitor the operation statuses of the storage devices first, and the multimedia splitting module 111 may splits the multimedia files into the multimedia segments according to the monitoring record of the storage monitoring module 113.

Because the multimedia storage system 100 need to store a large number of multimedia files, the number of storage devices needs to increase along with the gradually increased number of multimedia files. The consuming power and the dissipating heat accompanied with the increasing number of storage devices require the cooling system to maintain a suitable operation temperature of the multimedia storage system 100. Therefore, the storage devices of the multimedia storage system 100 may be configured to enter the low power consumption mode according to the characteristic of the multimedia file.

For example, the multimedia segment transmission module 115 may configured the multimedia segment with lower access frequency or fewer access numbers to be stored in the predetermined storage devices. Moreover when the available storage space of the predetermined storage devices is lower than a predetermined value, the predetermined storage device is configured to enter the low power consumption mode. In another embodiment, when the access frequency or the access number of the predetermined storage devices is lower than a predetermined value, the predetermined storage device is configured to enter the low power consumption mode. Therefore, the power consumption may be further reduced by configuring the storage devices to enter the low power consumption mode according to the characteristic of the multimedia file.

The multimedia system 100 may provide multiple level of redundancy protection by realizing the disk drive device of the storage device with RAID. Each of the multimedia segments not only has multiple duplications in multiple storage devices, but also has multiple duplications in the disk drive device of each the storage device. Therefore, the reliability of the multimedia segments may be further enhanced. In the above embodiments, the redundancy configuration of the multimedia system 100 is configured to be 1 for the purpose of clear explanation. In other embodiments, the redundancy configuration of the multimedia system 100 may be configured to be other suitable value for ensure the reliability of the multimedia files.

In the above embodiments, the multimedia storage system 100 may easily increase the available storage capacity by increasing the number of the storage devices. Moreover, the multimedia file may be suitably split and distributed to different storage devices to enhance the access speed so that the system loading may be reduced and the reliability of the multimedia files may be enhanced.

In the above embodiments, the multimedia storage system 100 may splits the multimedia file into multimedia segments with suitable sizes according to the characteristic of the multimedia files thereby enhance the performance of the multimedia storing operations.

In the above embodiments, the multimedia storage system 100 may configure the storage device to enter the low power consumption mode thereby reduce the power consumption.

In the above embodiments, the multimedia storage system 100 may still function normally even if some of the storage devices enter the low power consumption mode or do not operate normally.

Certain terms are used throughout the description and the claims to refer to particular components. One skilled in the art appreciates that a component may be referred to as different names. This disclosure does not intend to distinguish between components that differ in name but not in function. In the description and in the claims, the term “comprise” is used in an open-ended fashion, and thus should be interpreted to mean “include, but not limited to.” The phrases “be coupled with,” “couples with,” and “coupling with” are intended to compass any indirect or direct connection. Accordingly, if this disclosure mentioned that a first device is coupled with a second device, it means that the first device may be directly or indirectly connected to the second device through electrical connections, wireless communications, optical communications, or other signal connections with/without other intermediate devices or connection means.

The term “and/or” may comprise any and all combinations of one or more of the associated listed items. In addition, the singular forms “a,” “an,” and “the” herein are intended to comprise the plural forms as well, unless the context clearly indicates otherwise.

In the drawings, the size and relative sizes of some elements may be exaggerated or simplified for clarity. Accordingly, unless the context clearly specifies, the shape, size, relative size, and relative position of each element in the drawings are illustrated merely for clarity, and not intended to be used to restrict the claim scope.

Other embodiments of the invention will be apparent to those skilled in the art from consideration of the specification and practice of the invention disclosed herein. It is intended that the specification and examples be considered as exemplary only, with a true scope and spirit of the invention indicated by the following claims.

What is claimed is:

1. A multimedia storage system, comprising:
a plurality of first storage devices, each of which comprises at least one network access device and at least one disk drive device; and
a multimedia distribution device for splitting a first multimedia file into a plurality of multimedia segments and splitting a second multimedia file into a plurality of multimedia segments; wherein in a first period, the multimedia distribution device is coupled with the first storage devices for storing the multimedia segments of the first multimedia file into the first storage devices so that each of the multimedia segments of the first multimedia file is stored in at least two of the first storage devices; and in a second period, the multimedia distribution device is coupled with the first storage devices and a plurality of second storage devices for storing the multimedia segments of the second multimedia file so that each of the multimedia segments of the second multimedia file is stored in at least two of the first storage devices and the second storage devices;
wherein each of the second storage device comprises at least one network access device and at least one disk drive device; the network access devices of the first storage devices and the network access devices of the second storage devices are configured to operably receive the multimedia segments of the first multimedia file and the multimedia segments of the second multimedia file; the disk drive devices of the first storage devices and the disk drive devices of the second storage devices are configured to operably store the multimedia segments of the first multimedia file and the multimedia segments of the second multimedia file; the multimedia distribution device splits the first multimedia file so that each of the multimedia segments of the first multimedia file comprises a multimedia content of a continuous time period and starts with an intra frame; and at least two of the multimedia segments of the first multimedia file have different sizes.

2. The multimedia storage system of claim 1, wherein in a third period, a first number of the first storage devices enters a low power consumption mode and a second number of the first storage devices do not; the multimedia distribution device splits a third multimedia file into a plurality of multimedia segments and stores the multimedia segments of the third multimedia file into the second number of the first storage device and the second storage devices so that each of the multimedia segments of the third multimedia file is stored in at least two of the second number of the first storage devices and the second storage devices.

3. The multimedia storage system of claim 1, wherein in a fourth period, a third number of the first storage devices operate normally and a fourth number of the first storage devices do not, the multimedia distribution device splits a fourth multimedia file into a plurality of multimedia segments and stores the multimedia segments of the fourth multimedia file into the third number of the first storage device and the second storage devices so that each of the multimedia segments of the fourth multimedia file is stored in at least two of the third number of the first storage devices and the second storage devices.

4. The multimedia storage system of claim 3, wherein the multimedia distribution device reproduces a plurality of multimedia segments stored in the fourth number of the first storage devices according to the multimedia segments stored in the third number of the first storage devices and the second storage devices so that each of the multimedia segments stored in the fourth number of the first storage devices is stored in at least two of the third number of the first storage devices and the second storage devices.

5. The multimedia storage system of claim 1, wherein the multimedia distribution device further comprises:
a multimedia segment transmission module for selecting a fifth number of the first storage device according to at least one of an available storage space, an access frequency and an access number of the first storage devices for storing the multimedia segments of the first multimedia file so that each of the multimedia segments of the first multimedia file is stored in at least two of the fifth number of the first storage devices.

6. A multimedia distribution device of a multimedia storage system, comprising:
a multimedia splitting module for splitting a first multimedia file into a plurality of multimedia segments and splitting a second multimedia file into a plurality of multimedia segments; wherein each of the multimedia segments of the first multimedia file comprises a multimedia content of a continuous time period and starts with an intra frame; each of the multimedia segments of the second multimedia file comprises a multimedia content of a continuous time period and starts with an intra frame; at least two of the multimedia segments of the first multimedia file have different sizes; and at least two of the multimedia segments of the second multimedia file have different sizes;
a storage monitoring module for monitoring operation statuses of a plurality of storage devices;
a multimedia segment transmission module for coupling with a plurality of first storage devices for storing the multimedia segments of the first multimedia file into the first storage devices in a first period so that each of the multimedia segments of the first multimedia file is stored in at least two of the first storage devices, and coupling with the first storage devices and a plurality of second storage devices for storing the multimedia segments of the second multimedia file in a second period so that each of the multimedia segments of the second multimedia file is stored in at least two of the first storage devices and the second storage devices;
wherein each of the first storage devices and the second storage devices comprises at least one network access device and at least one disk drive device; the network access devices of the first storage devices and the network access devices of the second storage devices are configured to operably receive the multimedia segments of the first multimedia file and the multimedia segments of the second multimedia file; and the disk drive devices of the first storage devices and the disk drive devices of the second storage devices are configured to operably store the multimedia segments of the first multimedia file and the multimedia segments of the second multimedia file.

7. The multimedia distribution device of claim 6, wherein in a third period, the storage monitoring module detects a first number of the first storage devices enters a low power consumption mode so that only a second number of the first storage devices and the second storage device may be configured to store multimedia segments; the multimedia splitting module splits a third multimedia file into a plurality of multimedia segments and stores the multimedia segments of the third multimedia file into the second number of the first storage device and the second storage devices so that each of the multimedia segments of the third multimedia file is stored in at least two of the second number of the first storage devices and the second storage devices.

8. The multimedia distribution device of claim 6, wherein in a fourth period, the storage monitoring module detects a third number of the first storage devices do not operate normally so that only a fourth number of the first storage devices and the second storage device may be configured to store multimedia segments; the multimedia distribution device splits a fourth multimedia file into a plurality of multimedia segments and stores the multimedia segments of the fourth multimedia file into the fourth number of the first storage device and the second storage devices so that each of the multimedia segments of the fourth multimedia file is stored in at least two of the fourth number of the first storage devices and the second storage devices.

9. The multimedia distribution device of claim 8, wherein the multimedia segment transmission module reproduces a plurality of multimedia segments stored in the third number of the first storage devices according to the multimedia segments stored in the fourth number of the first storage devices and the second storage devices so that each of the multimedia segments stored in the third number of the first storage devices is stored in at least two of the fourth number of the first storage devices and the second storage devices.

10. The multimedia distribution device of claim 6, wherein the multimedia segment transmission module selects a fifth number of the first storage device according to at least one of an available storage space, an access frequency and an access number of the first storage devices for storing the multimedia segments of the first multimedia file so that each of the multimedia segments of the first multimedia file is stored in at least two of the fifth number of the first storage devices.

11. A computer program product, stored in a non-transitory storage device of a multimedia distribution device, when executed by a control circuit of the multimedia distribution device, enabling the multimedia distribution device to perform a multimedia storing operation, the computer program product comprising:
splitting a first multimedia file into a plurality of multimedia segments; wherein each of the multimedia segments of the first multimedia file comprises a multimedia content of a continuous time period and starts with an intra frame, and at least two of the multimedia segments of the first multimedia file have different sizes;
splitting a second multimedia file into a plurality of multimedia segments; wherein each of the multimedia segments of the second multimedia file comprises a multimedia content of a continuous time period and starts with an intra frame, and at least two of the multimedia segments of the second multimedia file have different sizes;
monitoring operation statuses of a plurality of storage devices;
in a first period, storing the multimedia segments of the first multimedia file into a plurality of first storage devices so that each of the multimedia segments of the first multimedia file is stored in at least two of the first storage devices; and
in a second period, storing the multimedia segments of the second multimedia file into the first storage devices and a plurality of second storage devices so that each of the multimedia segments of the second multimedia file is stored in at least two of the first storage devices and the second storage devices;
wherein each of the first storage devices and the second storage devices comprises at least one network access device and at least one disk drive device; the network access devices of the first storage devices and the network access devices of the second storage devices are configured to operably receive the multimedia segments of the first multimedia file and the multimedia segments of the second multimedia file; and the disk drive devices of the first storage devices and the disk drive devices of the second storage devices are configured to operably store the multimedia segments of the first multimedia file and the multimedia segments of the second multimedia file.

12. The computer program product of claim 11, wherein the multimedia storing operation further comprises:
in a third period, when a first number of the first storage devices enters a low power consumption mode so that only a second number of the first storage devices and the second storage device may be configured to store multimedia segments, splitting a third multimedia file into a plurality of multimedia segments and storing the multimedia segments of the third multimedia file into the second number of the first storage device and the second storage devices so that each of the multimedia segments of the third multimedia file is stored in at least two of the second number of the first storage devices and the second storage devices.

13. The computer program product of claim 11, wherein the multimedia storing operation further comprises:
in a fourth period, when a third number of the first storage devices do not operate normally so that only a fourth number of the first storage devices and the second storage device may be configured to store multimedia segments, splitting a fourth multimedia file into a plurality of multimedia segments and storing the multimedia segments of the fourth multimedia file into the fourth number of the first storage device and the second storage devices so that each of the multimedia segments of the fourth multimedia file is stored in at least two of the fourth number of the first storage devices and the second storage devices.

14. The computer program product of claim 13, wherein the multimedia storing operation further comprises:
reproducing a plurality of multimedia segments stored in the fourth number of the first storage devices according to the multimedia segments stored in the third number of the first storage devices and the second storage devices so that each of the multimedia segments stored in the fourth number of the first storage devices is stored in at least two of the third number of the first storage devices and the second storage devices.

15. The computer program product of claim 11, wherein the multimedia storing operation further comprises:
selecting a fifth number of the first storage device according to at least one of an available storage space, an access frequency and an access number of the first storage devices; and
storing the multimedia segments of the first multimedia file in to the fifth number of the first storage device so that each of the multimedia segments of the first multimedia file is stored in at least two of the fifth number of the first storage devices.
